(19) United States
(12) Patent Application Publication
(10) Pub. No.: US 2004/0002388 A1
(43) Pub. Date: Jan. 1, 2004

(54) Local casino management system populating and updating process

(75) Inventors: Gregory D. Larsen, Sun Valley, NV (US); George D. Paiva, Reno, NV (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Park Place Entertainment Corporation

(21) Appl. No.: 10/188,154

(22) Filed: Jul. 1, 2002

(51) Int. Cl. G06F 17/00

(52) U.S. Cl. 463/43

(57) ABSTRACT

Casino patrons are allowed to possess multiple identities at different casino properties within an affiliation of casino properties or at the same casino property within the casino enterprise, yet still be identified as the same patron. Patron identities are matched up based on identifying information provided by the patron, and a universal patron identifier number is assigned to each local patron account.

### BACKGROUND OF THE INVENTION

In recent years, the casino industry has evolved from being an industry of independent, unaffiliated casino properties to an industry of affiliated casino properties. In some instances, such as Harrah's, all of the casino properties have an identical corporate name and identity. In other instances, such as Station Casinos, Inc. and Park Place Entertainment (PPE), the casino properties have individual names but a single corporate identity (e.g., Palace Station Hotel & Casino, a Station Casinos property, The Flamingo, a PPE property). In yet other instances, independent casino properties have joined with each other to form loose networks with common marketing programs.

As casino properties have become affiliated, casino information management systems have also evolved to allow casino patrons to use a single player card at each of the affiliated properties. The single player card allows all of the patron's gaming and non-gaming activities to be monitored, tracked, and analyzed. Despite privacy concerns, casino patrons have willingly embraced the player cards for many reasons. For example, the player cards allow a patron to accumulate and flexibly redeem bonus points, comp points and the like over multiple visits and at multiple affiliated casino properties. The player cards thus have a similar appeal to casino patrons as frequent flier programs have for airline passengers.

Furthermore, the player cards offer convenience to the patron who can use the card for all gaming and non-gaming activity at a casino property. Patrons are also aware that enrollment in a player card program allows the patrons to receive targeted promotional solicitations that may be of interest to the patron and which may not otherwise be offered to the patron.

The casino properties greatly benefit from the player cards and the information generated by being able to individually track patron activity. One key benefit is that the casino properties can quickly and accurately evaluate what comps a patron should be offered and what bonus points the patron has accumulated and is entitled to redeem, regardless of which casino property within the affiliated network the patron is visiting. (Comps are complimentary gifts used by casinos to entice players to gamble. Typical comps include free room, food and beverage, free travel and even cash rebates.) Many systems have been developed to allow local casino properties to communicate with, and share data with, other local casino properties and with a central database to fulfill the information sharing needs regarding patron activity within the network of affiliated casino properties.

U.S. Pat. No. 5,761,647 (Boushy) and U.S. Pat. No. 6,302,793 (Fertitta, III et al.) disclose such systems. In general, these systems provide a central player or patron database which is in communication with a plurality of remote player or patron databases located at respective casino properties.

FIG. 5 of U.S. Pat. No. 5,761,647 further discloses a complex decentralized configuration wherein the central database is eliminated in favor of a distributed database. The decentralized configuration requires each local casino property to maintain a local guest master list (e.g., stores data for all casino patrons who received their player cards at the local casino property), a local cross-reference list (e.g., stores data for any casino patrons who received their player cards at any of the other affiliated casino properties and subsequently visited the local casino property), as well as virtual files which store data for patrons of the other affiliated casino properties who are not in either the local guest master list or the local cross-reference list (e.g., casino patrons who received their player cards at any of the other affiliated casino properties but who have not subsequently visited the local casino property). This configuration has numerous disadvantages, including at least the following disadvantages:

1. Each local casino property must maintain at least some data in one of its lists or files on every casino patron within the enterprise. Accordingly, each casino property must periodically communicate with each of the other casino properties, and then perform local comparison checking and processing functions, regardless of whether such data is needed at a particular casino property. For example, some casino patrons never visit different casino properties within the enterprise, and thus their data only needs to be stored at the one casino property that they visit.

2. A single customer identification number must be used to match up customers who visit multiple properties. If a customer receives a first player card having a first identification number at one casino property and then receives a second player card having a second identification number at another casino property within the same enterprise, the system will always presume that the customers are different. This may negatively impact comp decisions and the like when the customer visits each of the casino properties that they are registered at.

3. Player cards must include a property field that indicates which local casino property issued the account.

Casino management systems (also referred to as “player tracking systems”) track and store player activity at an extremely fine level of granularity and thus generate a tremendous amount of data. For example, the coin-in and coin-out of every spin of a slot machine may be separately recorded. As the number of affiliate properties and the patrons that they serve continue to grow in size, it has become difficult and expensive for casino management systems to track and store all of the player activity data of all of the patrons. Considerations such as data storage capacity and data communication bandwidth have made the current systems impractical. For example, it is not practical or cost-effective to maintain duplicate copies of patron activity data for all patrons at a central database, as well as each local casino property, and to constantly update central and local databases whenever there is patron activity at a specific casino property.

Affiliate property player card programs typically require the patron to use a common identity at all properties. That is, once John Smith registers for the program, John Smith is issued a single player card having a single account number. If John Smith goes to another affiliate casino property and requests another card, two scenarios may occur. In one scenario, John Smith identifies himself as an existing member of the casino network and the casino locates his account and issues him a duplicate card having the same account number. Any bonus points or comps earned using his duplicate card are credited towards his existing account. In a second scenario, no match is ever made with his existing membership because John Smith fails to identify himself as an existing member. In the second scenario, John Smith is issued a new player card with a new account number and thus any earned bonus points or comps are not credited to his existing account. The second scenario is much more likely to occur when the affiliate casino properties operate under different local names or where unaffiliated casino properties join together in common marketing programs. In some instances, the patrons may not even realize that the casino property that they are visiting is an affiliate property or a network property for which they already have a player card. It is advantageous for both the patron and the casino property to identify patrons who visit a local casino property and who are already registered at another affiliated or networked casino property.

Despite the development of many different types of multi-property casino management systems, there is still an unmet need for a system that can provide a more flexible approach to storing and sharing player activity data among affiliate casino properties while still allowing each local database to obtain immediate access to current patron activity data at every affiliate property when or if a comp decision or a bonus point redemption must be made. There is also an unmet need for a system that can more consistently identify common patrons at different affiliated casino properties even if the patrons are issued different account numbers. Furthermore, there is an unmet need for a simplified system for updating patron records at local casino properties that does not require communication with a central database of patron activity data. The present invention fulfills such needs.

### BRIEF SUMMARY OF THE INVENTION

A casino management system (CMS) of a local casino property is populated with patron activity data stored in patron records of CMS's at other affiliated casino properties when an existing patron of one of the other affiliated casino properties visits the local casino property which has no patron record in its CMS. Each patron record relates to a patron's local account number, and each local account number is assigned a universal patron identifier number (UID). The process operates in at least the following manner:

1. Identifying information obtained from the visiting patron is communicated to a remote account data repository. The remote account data repository includes all patron local account numbers, their assigned UID's, and the local CMS's where each local account number exists. The remote data repository also includes identifying information for each local account number.

2. The identifying information obtained from the visiting patron and the identifying information in the remote account data repository are used to locate a corresponding UID for the visiting patron in the remote account data repository.

3. The remote account data repository uses the UID to identify all local account numbers that correspond to the UID for the patron.

4. The local account numbers and the local CMS's where each of the local account number exist are communicated back to the CMS of the local casino property.

5. The CMS of the local casino property initiates communication directly with the CMS of each of the casino properties that have the local account numbers, and retrieving the patron records of the identified local account numbers directly from the CMS's of the other casino properties. This process occurs without further assistance from the remote account data repository or a central database of patron activity data.

6. The CMS of the local casino property creates a new patron record for the visiting patron and adds the retrieved patron records to its data records. The local casino property thereby populates the local CMS with patron records of the visiting patron from the other casino properties.

In another embodiment of the present invention, a casino management system (CMS) of a local casino property is populated with patron activity data stored in patron records of CMS's at other affiliated casino properties when an existing patron of one of the other affiliated casino properties visits the local casino property which has no patron record in its CMS. Each patron record relates to a patron's local account number, and each local account number is assigned a universal patron identifier number (UID). The process operates in at least the following manner:

1. A local account number obtained from the visiting patron is communicated to a remote account data repository. The remote account data repository includes all patron local account numbers, their assigned UID's, and the local CMS's where each local account number exists.

2. The local account number obtained from the visiting patron is used to locate a corresponding UID for the visiting patron in the remote account data repository.

3. The remote account data repository uses the UID to identify all local account numbers that correspond to the UID for the patron.

4. The local account numbers and the local CMS's where each of the local account numbers exist are communicated back to the CMS of the local casino property.

5. The CMS of the local casino property initiates communication directly with the CMS of each of the casino properties that have the local account numbers, and retrieves the patron records of the identified local account numbers directly from the CMS's of the other casino properties. This process is performed without further assistance from the remote account data repository or a central database of patron activity data.

6. The CMS of the local casino property creates a new patron record for the visiting patron and adds the retrieved patron records to its data records. The local casino property thereby populates the local CMS with patron records of the visiting patron from the other casino properties.

In another embodiment of the present invention, a casino management system (CMS) of a local casino property is updated with patron activity data stored in patron records of CMS's at other affiliated casino properties when a patron of the local casino property visits the local casino property. Each patron record relates to a patron's local account number, and each local account number is assigned a universal patron identifier number (UID). The process operates in at least the following manner:

1. An update function is selected at the local CMS.

2. A local account number obtained from the visiting patron who has a preexisting patron record in the CMS of the local casino property is communicated to a remote account data repository. The remote account data repository includes all patron local account numbers, their assigned UID's, and the local CMS's where each local account number exists.

3. The local account number obtained from the visiting patron is used to locate a corresponding UID for the visiting patron in the remote account data repository.

4. The remote account data repository uses the UID to identify all local account numbers that correspond to the UID for the patron.

5. The local account numbers and the local CMS's where each of the local account number exist are communicated back to the CMS of the local casino property.

6. The CMS of the local casino property initiates communication directly with the CMS of each of the casino properties that have the local account numbers, and retrieves the patron records of the identified local account numbers directly from the CMS's of the other casino properties. This process is performed without further assistance from the remote account data repository or a central database of patron activity data.

7. The CMS of the local casino property updates its patron record for the visiting patron with any retrieved patron records from the other casino properties. The local casino property thereby updates the local CMS with patron records of the visiting patron from the other casino properties.

In another embodiment of the present invention, a computer-implemented process is provided which allows a patron to have more than one local account number within an enterprise of affiliated local casino properties while allowing local casino management systems (CMS's) at the local casino properties to store and relate the multiple account numbers to each other. The process operates in at least the following manner:

1. An existing patron of one of the affiliated local casino properties is allowed to obtain a new local account number at any of the affiliated local casino properties. The patron provides identifying information when obtaining the new local account number. The identifying information may include information such as the existing patron's name, address, telephone number, birthday or birth date, social security number, driver's license, and the like.

2. A universal patron identifier number (UID) is assigned to each local account number. The same UID is assigned to each local account number that has sufficiently similar identifying information to determine that the respective identities of the patrons are the same.

3. The local account numbers, identifying information associated with the local account numbers, and the UID's for each of the local account numbers are stored in a remote account data repository. The UID for the existing patron who obtains a new local account number is assigned using the data in the remote account data repository.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIGS. 1A and 1B are schematic block diagrams of preferred embodiments of the present invention;

FIG. 2 shows an overview of the data elements in each of the local casino management systems for one preferred embodiment of the present invention;

FIG. 3 shows an overview of the data elements in a patron identity server populated with sample data to illustrate its function;

FIGS. 4A and 4B, taken together, shows a flowchart of the process for assigning local account numbers and universal patron identifier numbers (UID's), and for populating a local casino management system with patron records;

FIG. 5 shows a flowchart of the process for updating a local casino management system with current patron record data;

FIG. 6 shows an example of the data elements in FIG. 2 for a casino management system of a local casino property, populated with data that relates to the data in the patron identity server example of FIG. 3;

FIG. 7 shows a flowchart of how the present invention may be used in making comp decisions; and

FIG. 8 shows sample display screens that a casino employee views during the comp process.

### DETAILED DESCRIPTION OF THE INVENTION

Certain terminology is used herein for convenience only and is not to be taken as a limitation on the present invention. In the drawings, the same reference letters are employed for designating the same elements throughout the several figures.

1. Overview of Present Invention

For simplicity, the word “affiliated” will be used to describe a plurality of casino properties that share data among themselves, either as part of a common enterprise having the same corporate identity, or as part of the same network, or as part of a common marketing program. The scope of the present invention includes any combinations or permutations of these arrangements.

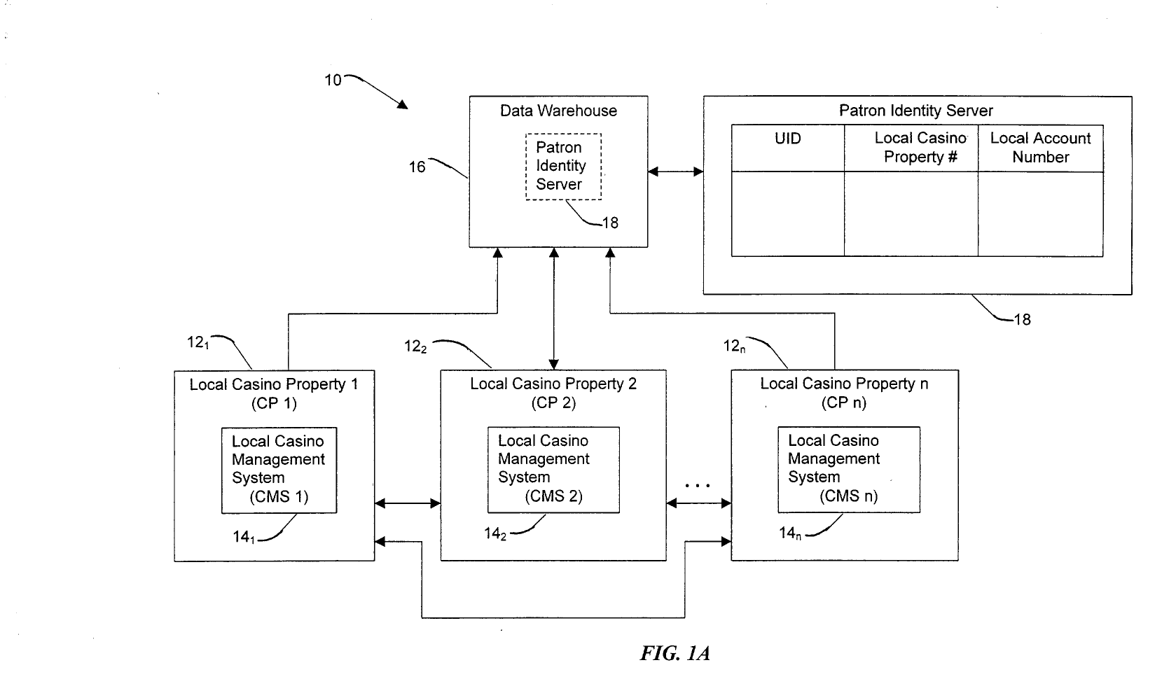

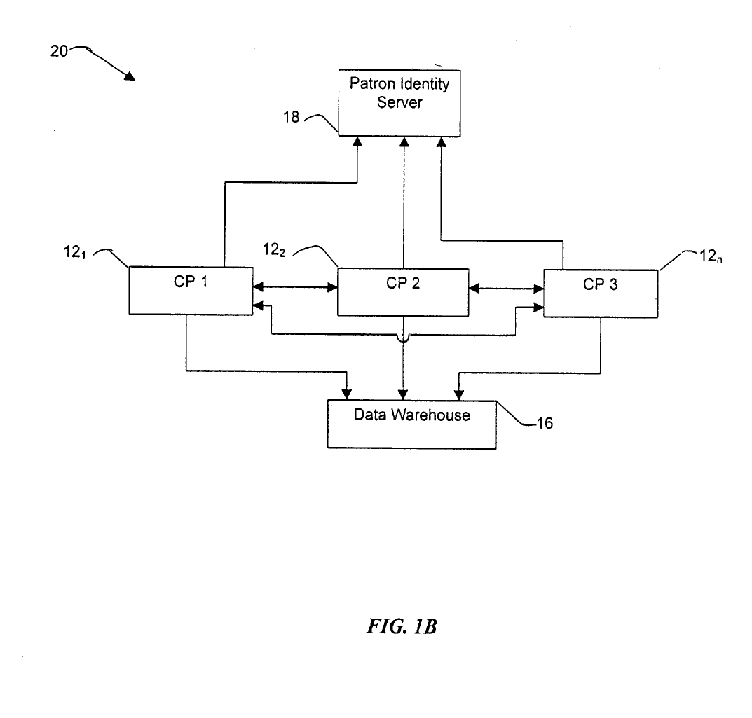

FIGS. 1A and 1B show two preferred embodiments 10 and 20, respectively, of the present invention, both of which have three major components:

(1) A plurality of affiliated, independently operating local casino properties (CP1, CP2, . . . CPn), labeled as 12₁, 12₂, . . . 12ₙ, each one having its own local casino management system (CMS1, CMS2, . . . CMSn), labeled as 14₁, 14₂, . . . 14ₙ. Each of the CMS's may communicate directly with each of the other CMS's.

(2) A data warehouse 16 that is in communication with each of the local CMS's 14 and which receives and stores patron activity data, including rating information, from each of the local CMS's 14 on a periodic basis, such as once per day, or when it requests such data in a polling process. The data warehouse 16 is an optional component. However, in one preferred embodiment of the present invention described herein, the data warehouse 16 is an integral part of a data storage process wherein each local CMS 14 stores patron activity data for the most recent visits of each patron (e.g., last three visits), and the data warehouse 16 stores historical patron activity data for all patron visits. In this manner, the storage capacity of the local CMS's 14 can be kept to a manageable capacity.

(3) A patron identity server 18 which assigns universal patron identifier numbers (UID's) to each local CMS patron account number and stores the UID's. The patron identity server also stores each local CMS patron account number, the patron identity information associated with each patron account number, and the location or locations of each local CMS that contains each local CMS patron account number. For example, the patron identity server 18 may indicate that local patron account number 1234 has an associated UID of U1111, and that a patron record this local patron account number exists in local casino properties 1 and 2, and that local patron account number 1667 has an associated UID of U1112, and that a patron record for this local patron account number exists only in local casino property 2. When a patron who has no presence in a particular local CMS 14 wishes to register at the particular local CMS 14, the patron identity server 18 uses patron provided identity information to determine if the patron has a previous identity as a result of one or more previous registrations at any of the affiliated local casino properties 12. If so, the UID is associated with the new patron's account. No patron activity data, such as rating information, is stored in the patron identity server 18.

The patron identity server 18 may be configured in at least three different ways. In a first configuration shown in FIG. 1A, it is part of the data warehouse 16, but has a different data structure than the data warehouse 16. In a second configuration, also shown in FIG. 1A, it is in communication with, but physically separate from, the data warehouse 16. In a third configuration shown in FIG. 1B, it is physically separate from, and not in communication with, the data warehouse 16.

In one preferred embodiment, each local CMS 14 may communicate directly with each of the other local CMS's 14 without receiving any assistance from the data warehouse 16. Furthermore, the data warehouse 16 only receives patron activity data from the local CMS's 14 and does not share or send any patron activity data among the local CMS's 14 as part of a patron record updating process.

Some advantages of the system in the present invention are as follows:

(1) It is not necessary to communicate with, or even maintain, a central patron (player) database, since there is no central database of current player activity data that is maintained for the purposes of populating and updating local CMSs 14. However, a central database (i.e., data warehouse 16) is used in the preferred embodiment described herein to reduce the data storage needs of the local CMS's 14 and to provide an offline source of data for batch-type analysis, such as historical data mining and development of marketing programs.

(2) The data structure and contents of the data warehouse 16 need not be compatible with local CMS's 14. The data warehouse 16 merely must understand what data is flowing in from the local CMS's 14 during the batch updating. Once the data is in the data warehouse 16, it can be stored and reformatted without regard to the manner in which data is organized in the local CMS's 14. Accordingly, the data warehouse 16 may be continuously reconfigured without affecting the operation of the local CMS's 14 and without requiring that corresponding changes be made to the local CMS's 14. This enhances the cost effectiveness and usefulness of the data warehouse 16. For example the data warehouse 16 may store patron activity data in a format that is more suitable for metrics-related queries and marketing program decisions than for populating and updating patron records in a format used by the local CMS's 14. Furthermore, as discussed above, the data warehouse 16 allows the local CMS's 14 to significantly reduce the amount of historical data that they must keep since the data warehouse 16 can store such data.

(3) Each local CMS 14 does not need to store patron records for patrons who have visited an affiliated casino property 12 but have never visited that particular local casino property 12.

(4) Patrons can have more than one identity at a single casino property 12, or at different casino properties 12, but can still be tied into the same UID for purposes of enterprise/affiliate identification. As noted above, it is advantageous for both the patron and the casino property to identify patrons who visit a local casino property and who are already registered at another affiliated or networked casino property. Nonetheless, the identification process should ideally be non-labor intensive and non-intrusive to the patron. For example, the patron may fill out a registration form with a slightly different permutation of a name or with a different address than the patron used at another casino property. In some instances, the differences in information may be deliberate and may be made for personal or private reasons. Regardless of the reasons for discrepancies, the patron identity server makes the identification match. The local casino property can thus process the registration form without needing to ask the patron to explain any discrepancies or make any changes.

The patron thus can receive different player identification cards for different, affiliated casino properties, but still be recognized by the casino entity as the same patron. In one embodiment of the present invention, each local account stores its own player activity data, and each local account earns and redeems its own bonus points and comp points. In another embodiment, bonus points and comp points for local accounts that relate to the same patron may be pooled when earning and redeeming such points.

2. Detailed Description

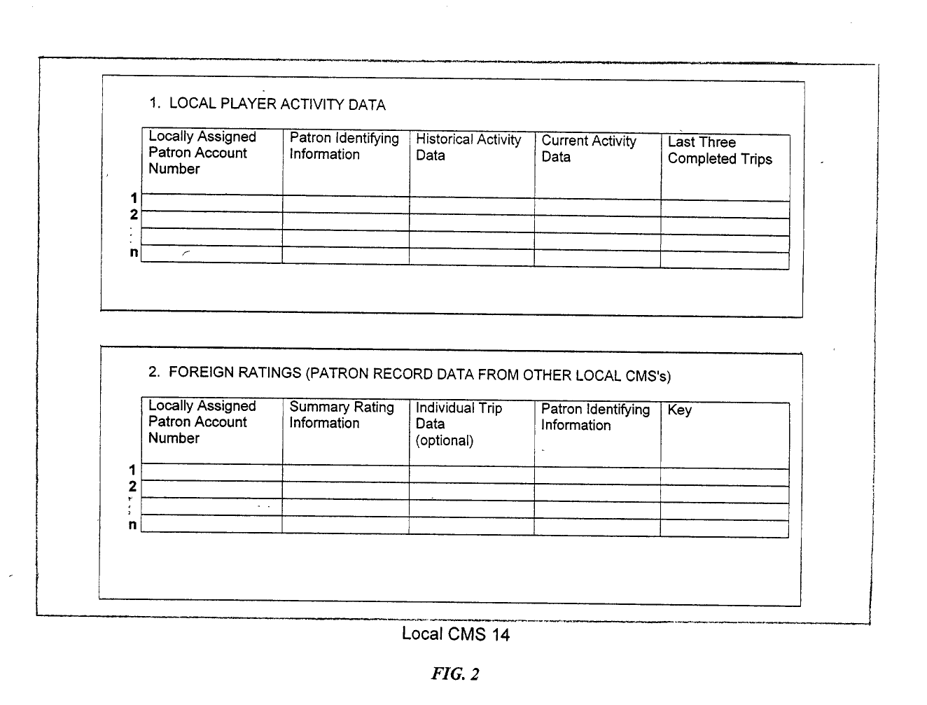

FIG. 2 shows an overview of the data elements in each of the local CMS's 14 for one preferred embodiment of the present invention. The local CMS's 14 includes at least the following data separated into two subparts described below:

1. Local Player Activity Data

a. locally assigned patron account number. This is typically the same as the patron's account number which may also be printed on a player card and/or encoded in a magnetic strip of the player card. The account number may have been assigned by any of the affiliated casino properties. The account number may optionally have fields indicating which local property issued the account. One example of such a player card is a slot club card, such as the “Universal Card,” issued by properties owned by Park Place Entertainment.

b. patron identifying information. This includes data such as name, address, telephone number(s), driver's license, birthday or birth date, social security number, email address, and the like.

c. historical activity data. This includes historical rating information based on player activity data at the local casino property over a plurality of past trips.

d. current activity data. This includes player activity data, including rating information, for a trip in progress.

e. last three completed trips. This includes separate records of player activity data for each of the player's last three completed trips.

These data elements a-e are conventional data stored by prior art CMS software programs.

2. foreign ratings—Patron Records from Local CMS's of Other Local Affiliated Casino Properties

This may include individual trip data (highly granular data) and/or historical activity data, also referred to as “Summary Rating” information (less granular data) from any other local casino properties that the patron has visited. The patron records are those that relate to the same locally assigned patron account number, and thus inherently have the same UID as tracked by the patron identity server 18. Any patron records that have different locally assigned patron account numbers, but the same UID as tracked by the patron identity server 18, are also stored in this subpart. Each patron record in the foreign ratings has a key to associate it with a related locally assigned patron account number stored in subpart 1. That is, if a foreign rating is related to a patron record that shares the same UID as tracked by the patron identity server 18, then the key for that patron record will be the locally assigned patron account number in the first subpart. In this embodiment of the present invention, the UID itself is not stored in the local CMS 14 but is only stored in the patron identity server 18.

The foreign ratings relate to the present invention.

The local CMS may be implemented using any suitable commercially available CMS/player tracking system. One suitable system is SDS® Slot Data System, available from the Bally Gaming Systems subsidiary of Alliance Gaming Corp., Las Vegas Nev. Another suitable system is OASIS or OASIS II, both available from Aristocrat Technology, Inc., Las Vegas, Nev. (formerly known as Casino Data Systems (CDS)).

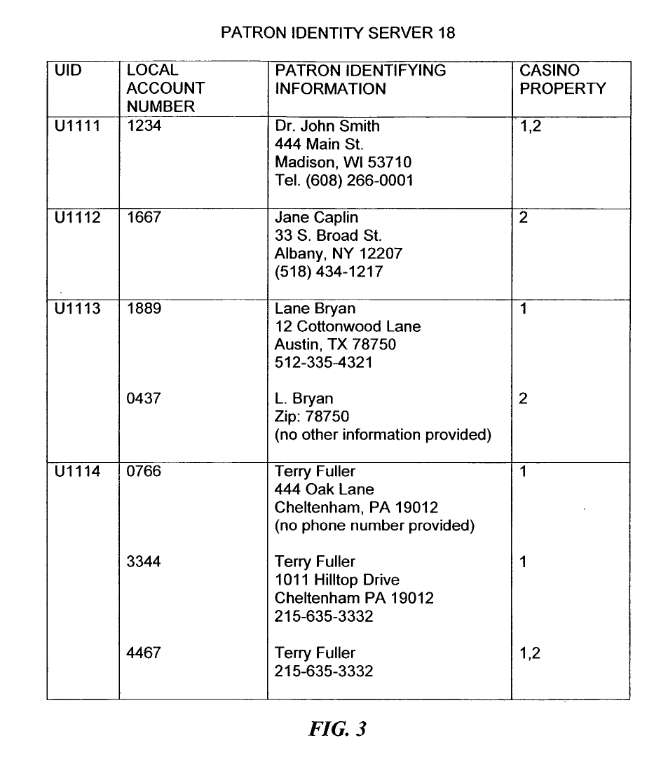

FIG. 3 shows an overview of the data elements in the patron identity server 18 populated with sample data to illustrate its function. The patron identity server 18 includes every UID assigned to a local account number, and the related locally assigned patron account number and patron identifying information for each of the UID's. The patron identity server 18 further includes a field indicating which of the local casino properties 14 have a patron record that matches the locally assigned patron account number.

The sample data in FIG. 3 illustrates an important feature of the present invention, namely, the ability to allow each patron to have multiple identities, if desired.

Patron U1111: This patron has only one identity and uses the same identity at affiliated casino properties 1 and 2.

Patron U1112: This patron has only one identity and uses it at only at casino property 2.

Patron U1113: This patron has two different local identities. The patron submitted relatively complete identifying information when initially registering at casino property 1. The patron then registered at casino property 2, but provided only minimal identifying information. Nonetheless, a software program determined that this patron is, in fact, the same patron that was previously registered at casino property 1. Thus, the patron's new local account number was assigned the same UID as the first local account number.

Patron U1114: This patron has three different local identities. This patron returned to the same casino property 1 that she registered at before, and for any number of reasons, filled out a new registration form. The patron had moved between the first and second registrations. Nonetheless, the software program determined that the patron is, in fact, the same patron that was previously registered at that casino property. Thus, the patron's new local account number at casino 1 was assigned the same UID as the first local account number. Then, the patron visited casino 2 but provided only minimal identifying information. Nonetheless, a software program determined that this patron is, in fact, the same patron that was previously registered at casino property 1. Thus, the patron's new local account number was assigned the same UID as the first and second local account number.

The general process of identity matching is well-known in the art. In one preferred embodiment of the present invention, Trillium Software is used to perform the matching. Specific Trillium Software modules used for the matching process include the Parser, US Postal Geocoder, US Census Geocoder and Matcher. Trillium Software is a commercially available product. Trillium Software is a division of Harte-Hanks, Billerica, Mass. Other identity matching software may be used as well.

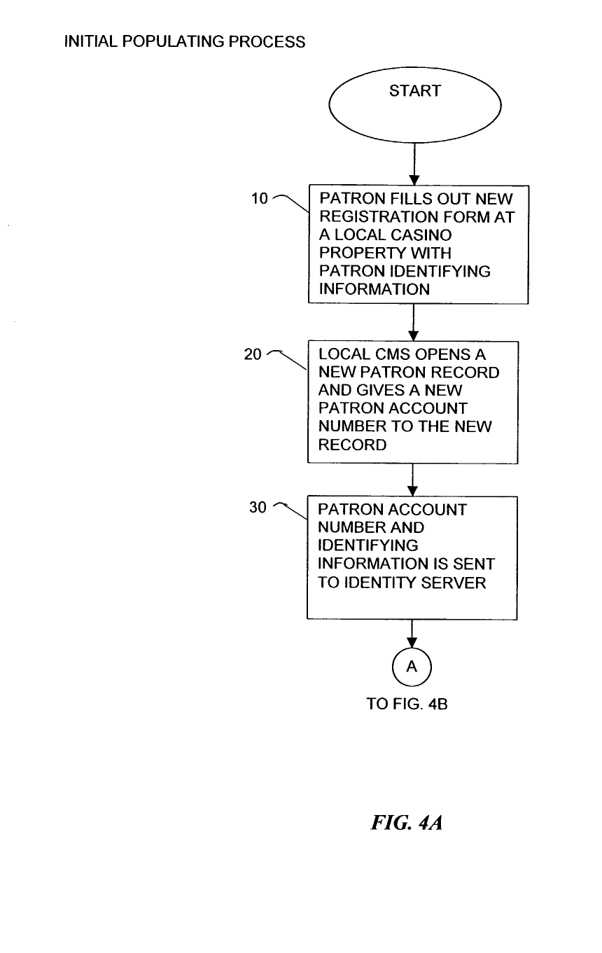

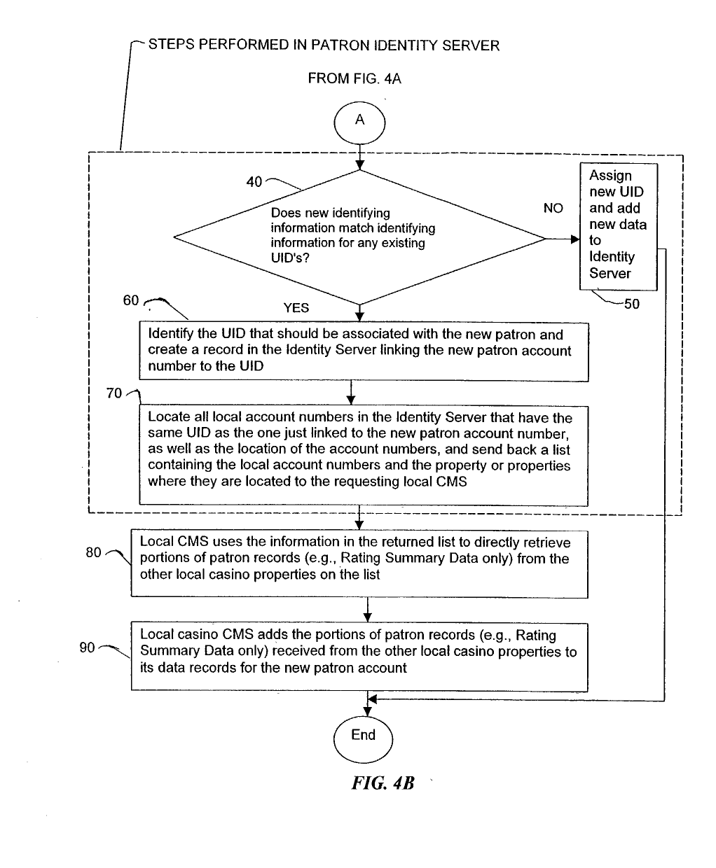

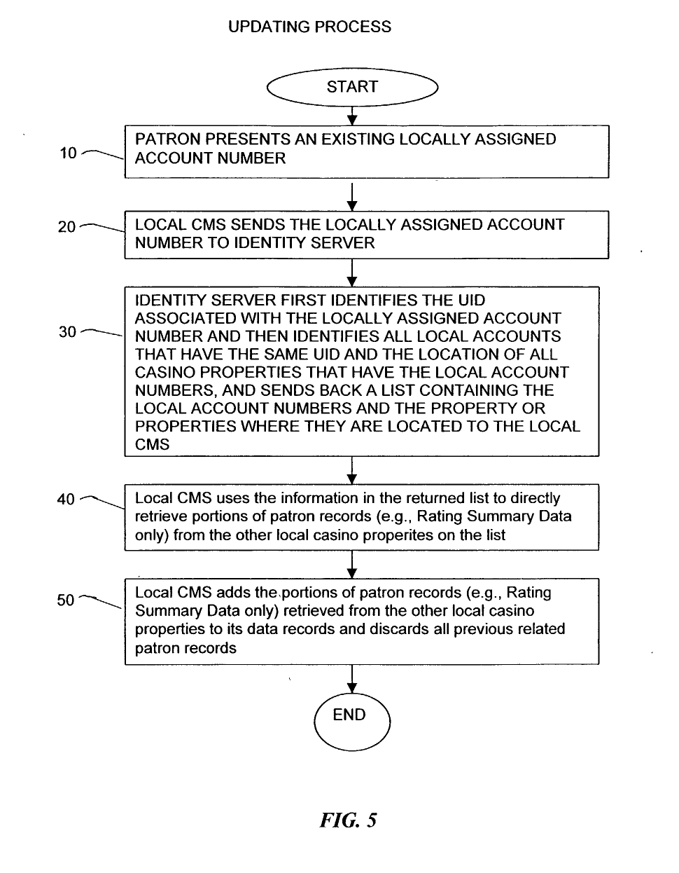

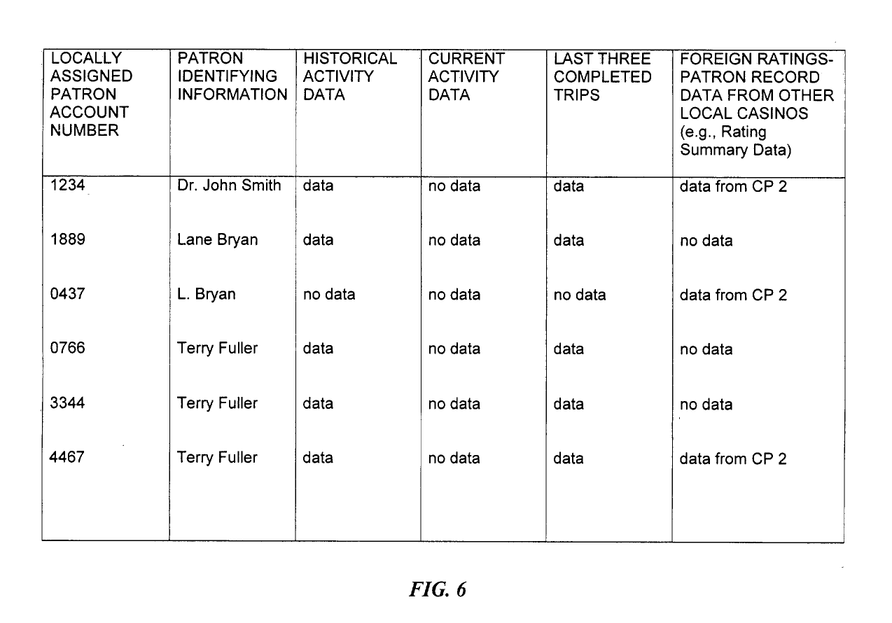

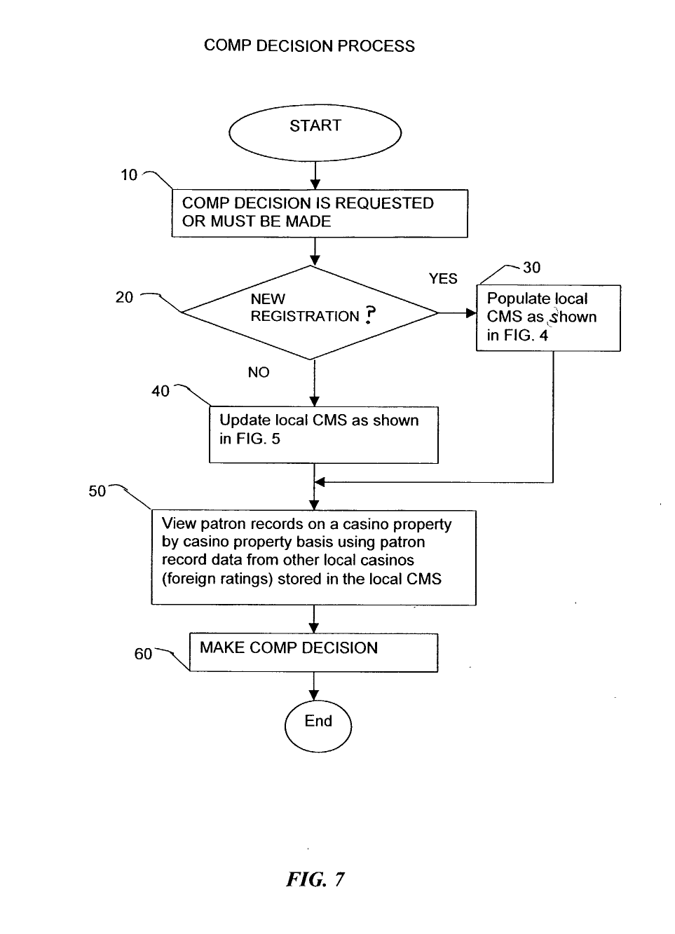

FIGS. 4A and 4B, taken together, show a self-explanatory flowchart of the process for assigning local account numbers and UID's, and for populating a local CMS 14 with patron records when a patron visits a local casino property and fills out a new registration form. If the patron is new to the enterprise of affiliate casino properties, as determined by the lack of a match of identifying information in the patron identity server 18, then a new local account number and a new UID is assigned to the patron, and no communication occurs with the other local casino properties 12 (“NO” output of step 40 and step 50). However, if the patron is not new to the enterprise of affiliate casino properties, as determined by a match of identifying information in the patron identity server 18, then a new local account number and an existing UID is assigned to the patron (“YES” output of step 40 and step 60). Furthermore, communication is initiated by the local CMS 14 that the patron is visiting with the local CMS's 14 of the other local casino properties 12 that are identified in the identity server 18 as having local account numbers related to the same UID, and player activity data (Foreign Ratings, such as Rating Summary Data) is received by and stored in the local CMS (steps 60, 70, 80, 90).

FIG. 5 shows a self-explanatory process for updating a local CMS with current patron record data. The process in FIG. 5 is similar in part to the process that occurs in FIGS. 4A, 4B when a patron who is not new to the enterprise of affiliate casino properties registers at a local casino property. More specifically, the identity server 18 is used to generate a list of local account numbers that must be retrieved from other local CMS's 14 and the location (i.e., local casino property or properties 12) that they must be retrieved from. During the updating process, any patron records that originated from other local casino CMS's 14 and that are currently stored in the local CMS 14 should be deleted since the newly received patron records should reflect the most current patron activity data.

FIG. 6 shows an example of the data elements in FIG. 2 for CMS 1 of local casino property 1, populated with data that relates to the data in the patron identity server example of FIG. 3. In this example, the casino entity has two affiliated properties, none of the patrons are currently visiting the local casino property 1, and it is assumed that all of the data for the patrons have been recently updated. Also, in this configuration, the fields for “HISTORICAL ACTIVITY DATA,” “CURRENT ACTIVITY DATA,” and “LAST THREE COMPLETED TRIPS” relate only to patron activity data for the local casino property 1. Any patron activity data for other casino properties is stored in the field for “PATRON RECORD DATA FROM OTHER LOCAL CASINOS” which may include some or all of this data at whatever level of granularity is desired by the system. Also, in FIG. 6, the PATRON IDENTIFYING INFORMATION shows only the name, whereas the actual data would include some or all of the identifying information shown in FIG. 3 for the respective patron.

Referring to FIG. 6, Dr. John Smith has the same patron identity at both local casino properties because Dr. Smith has a single player card and uses it at both casino properties. The local CMS 1 stores patron activity data for Dr. Smith's activity at the local casino property 1. Patron activity data from Dr. Smith's activity at casino property 2 is stored in the field for “PATRON RECORD DATA FROM OTHER LOCAL CASINOS.” As discussed above, this data may be individual trip data and/or historical activity data.

Lane Bryan has different patron identities at each of the local casino properties and thus does not use the same player card at each of the casino properties. The local CMS 1 thus has two different entries for this patron, but both entries relate to the same UID as tracked by the patron identity server 18. Since this patron has never used his 1889 identity at casino property 2, there is no data in the field for “PATRON RECORD DATA FROM OTHER LOCAL CASINOS.” Likewise, since this patron has never used his 0437 identity at casino property 1, there is no data in the fields for “HISTORICAL ACTIVITY DATA” or “LAST THREE COMPLETED TRIPS.” As discussed above, in the embodiment of the present invention described herein, these fields are populated only with patron activity data for the local casino property 1.

Terry Fuller has four entries in the local CMS 1 that relate to three different local identity, but each entry relates to the same UID as tracked by the patron identity server 18.

Jane Caplin has never visited the local casino property 1, and thus the local CMS 14 has no entry for her.

The databases in the local CMS's 14 and the patron identity server 18 may be organized in many different ways, and the scope of the present invention includes other arrangements. For example, the patron identity server 18 may be organized by local patron account number (i.e., one record entry for each unique local patron account number, instead of one record entry for each unique UID as shown in FIG. 3). Regardless of the particular organization of the databases, each local account number has an associated single UID as tracked by the patron identity server 18 so that patron records can be matched up regardless of the local casino that the patron has visited and regardless of the patron's local identity.

The local account numbers may be assigned either by the local CMS's 14, with each local CMS 14 authorized to use a non-overlapping range of numbers, or by the patron identity server 18. If the patron identity server 18 assigns the local account number, then steps 20 and 30 of FIG. 4A are modified so that only the identifying information is sent to the patron identity server 18, and a new step is added within the steps performed in the patron identity server 18 to assign the local account number and send it back to the local CMS 14.

In a small number of some circumstances, a previously registered patron may register with an identity that cannot be properly matched because the identifying information is insufficient to make an accurate match, because the patron has given deliberately inaccurate information to thwart the matching process, or for other reasons. However, in most situations, an accurate match should be possible. Furthermore, in some instances, the casino entity may wish to manually link certain local patron accounts with other local patron accounts that were not identified by the automated process of identity matching (step 40 of FIGS. 4A, 4B). For example, a patron may request that two of his or her accounts be linked, or the casino entity may independently decide that two accounts should be linked. The Trillium Software includes a Manual Trillium Link Maintenance function that can perform this task. This task would be performed by a user interfacing directly with the patron identity server 18.

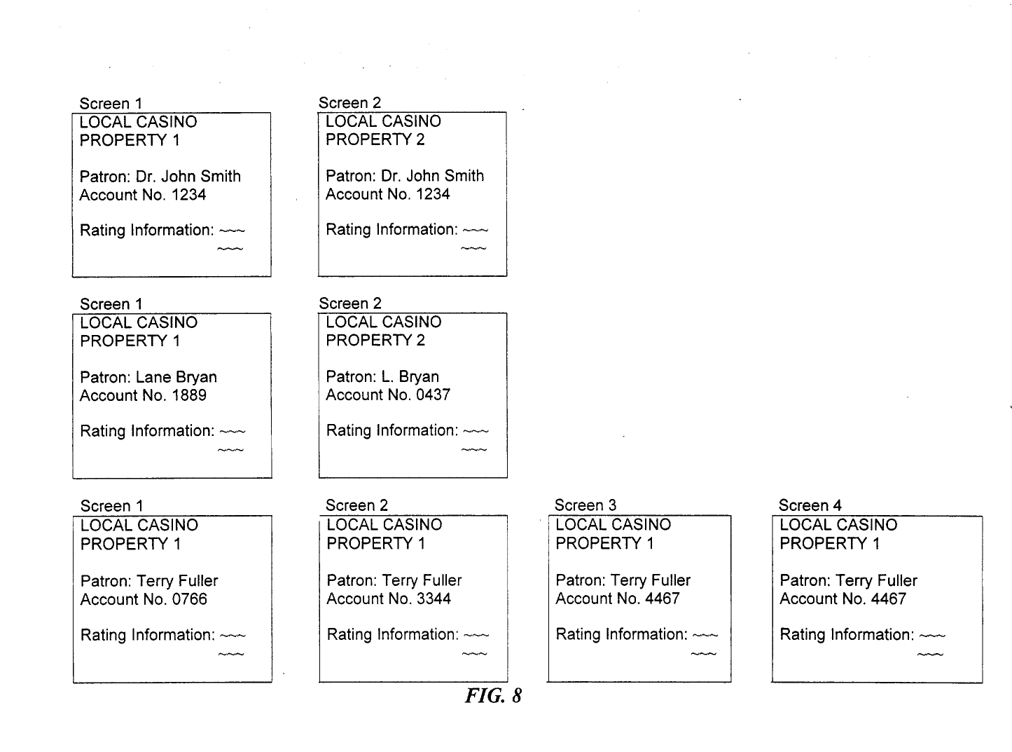

FIG. 7 shows a self-explanatory flowchart of how the present invention may be used in making comp decisions. FIG. 8 shows sample display screens that a casino employee views during the process. The comp decision may be initiated either by a patron request, or it may be part of a new patron registration process (e.g., all new patrons are evaluated for a potential comp regardless of whether they request it).

Referring to FIG. 8, a comp decision is being made with respect to patrons Dr. Smith, Lane Bryan and Terry Fuller, each of whom are visiting local casino property 1. Regardless of the patron identity used by the patron, all of the relevant rating information can be viewed when making the comp decision. One particularly useful piece of rating information for making a comp decision is the patron's “theoretical win” or TW, also known as “earning potential.” Theoretical win is the amount of money that the casino thinks it can win from a gambler, based on time played, average bet per hand, and the casino advantage. Stated another way, it is the amount of money that the casino predicts that the player will win (or lose) at the casino over a given time period (e.g., an hour, a day, a trip). Theoretical win is part of the player's rating.

In a conventional scheme wherein an individual must be identified by a single account number, the multiple identities used by patrons Lane Bryan and Terry Fuller (either by accident or by deliberate design) would not be revealed, and the local casino property would see only one screen of rating information. Accordingly, the comp decision would not take into account all of the information that the casino enterprise knows about these patrons, and thus the comp decision may not be accurate.

In addition to making better comp decisions, the UID may be used to assist the casino enterprise in gauging the number of unique patrons that it serves, as well as to more strategically target patrons in marketing programs by identifying patrons who may have multiple local accounts among affiliate casino properties. In one preferred embodiment of the present invention, each local account number retains its own bonus point and comp point totals. In this embodiment, a patron who wishes to accumulate all bonus points and comp points under the same local account must have only one patron identity, and thus only one local account. In the example shown herein, Dr. Smith has only one such account.

In an alternative embodiment of the present invention, the UID allows the casino enterprise to easily share bonus points and/or comp points among a plurality of local accounts (i.e., different patron identities). When operating a casino enterprise in this manner, care must be taken to ensure that patrons who have deliberately established separate identities are not openly treated as the same patron regardless of which identity the patron is currently using.

The present invention is particularly useful when an existing casino is purchased by a casino enterprise or becomes part of a joint marketing program, and the existing casino (i.e., affiliating casino property) does not wish to require its local patrons to turn in their local player cards in exchange for a player card associated with the purchasing casino enterprise or the joint marketing entity. Instead, the patron records can be fed into the patron identity server 18 and new or existing UID's may be associated with each patron, depending upon whether the patron is also enrolled at a local casino property of the new enterprise or marketing entity.

Furthermore, as casino enterprises establish a greater Internet presence through online affiliates or subsidiaries, many patrons may register with the new virtual entities without identifying themselves as belonging to an existing and affiliated physical casino enterprise. The present invention may be used to more accurately track the on-line patrons and to make appropriate marketing decisions about such casino patrons.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method of populating a casino management system (CMS) of a local casino property with patron activity data stored in patron records of CMS's at other affiliated casino properties when an existing patron of one of the other affiliated casino properties visits the local casino property which has no patron record in its CMS, wherein each patron record relates to a patron's local account number, and each local account number is assigned a universal patron identifier number (UID), the method comprising:
(a) communicating identifying information obtained from the visiting patron to a remote account data repository, the remote account data repository including
(i) all patron local account numbers, their assigned UID's, and the local CMS's where each local account number exists, and
(ii) identifying information for each local account number;
(b) using the identifying information obtained from the visiting patron and the identifying information in the remote account data repository to locate a corresponding UID for the visiting patron in the remote account data repository;
(c) in the remote account data repository, using the UID to identify all local account numbers that correspond to the UID for the patron;
(d) communicating the local account numbers and the local CMS's where each of the local account number exist back to the CMS of the local casino property;
(e) the CMS of the local casino property initiating communication directly with the CMS of each of the casino properties that have the local account numbers, and retrieving the patron records of the identified local account numbers directly from the CMS's of the other casino properties and without further assistance from the remote account data repository or a central database of patron activity data; and
(f) the CMS of the local casino property creating a new patron record for the visiting patron and adding the retrieved patron records to its data records, the local casino property thereby populating the local CMS with patron records of the visiting patron from the other casino properties.

2. The method of claim 1 wherein at least some visiting patrons have more than one local account number, each of the local account numbers being assigned the same UID in the remote account data repository, wherein step (e) further comprises retrieving each of the local account number records for the patrons that have more than one local account number.

3. The method of claim 2 wherein the identifying information for the local account numbers of the patrons that have more than one local account number may be different for each of the local account numbers.

4. The method of claim 1 further comprising:
(g) assigning the visiting patron a new local account number, wherein the new patron record created in step (f) is associated with the new local account number.

5. The method of claim 1 further comprising:
(g) viewing the patron records of the visiting patron for each of the casino properties on a display screen on an individual property by property basis.

6. The method of claim 1 wherein the identifying information includes one or more of the visiting patron's name, address, and telephone number.

7. The method of claim 1 wherein step (b) is performed by determining which identifying information in the remote account data repository is sufficiently similar to the identifying information obtained from the visiting patron.

8. A method of populating a casino management system (CMS) of a local casino property with patron activity data stored in patron records of CMS's at other affiliated casino properties when an existing patron of one of the other affiliated casino properties visits the local casino property which has no patron record in its CMS, wherein each patron record relates to a patron's local account number, and each local account number is assigned a universal patron identifier number (UID), the method comprising:
(a) communicating a local account number obtained from the visiting patron to a remote account data repository, the remote account data repository including all patron local account numbers, their assigned UID's, and the local CMS's where each local account number exists;
(b) using the local account number obtained from the visiting patron to locate a corresponding UID for the visiting patron in the remote account data repository;
(c) in the remote account data repository, using the UID to identify all local account numbers that correspond to the UID for the patron;
(d) communicating the local account numbers and the local CMS's where each of the local account numbers exist back to the CMS of the local casino property;
(e) the CMS of the local casino property initiating communication directly with the CMS of each of the casino properties that have the local account numbers, and retrieving the patron records of the identified local account numbers directly from the CMS's of the other casino properties and without further assistance from the remote account data repository or a central database of patron activity data; and
(f) the CMS of the local casino property creating a new patron record for the visiting patron and adding the retrieved patron records to its data records, the local casino property thereby populating the local CMS with patron records of the visiting patron from the other casino properties.

9. The method of claim 8 further comprising:
(g) viewing the patron records of the visiting patron for each of the casino properties on a display screen on an individual property by property basis.

10. The method of claim 8 wherein at least some visiting patrons have more than one local account number, each of the local account numbers being assigned the same UID in the remote account data repository, wherein step (e) further comprises retrieving each of the local account number records for the patrons that have more than one local account number.

11. A method of updating a casino management system (CMS) of a local casino property with patron activity data stored in patron records of CMS's at other affiliated casino properties when a patron of the local casino property visits the local casino property, wherein each patron record relates to a patron's local account number, and each local account number is assigned a universal patron identifier number (UID), the method comprising:
(a) selecting an update function at the local CMS;
(b) communicating a local account number obtained from the visiting patron who has a preexisting patron record in the CMS of the local casino property to a remote account data repository, the remote account data repository including all patron local account numbers, their assigned UID's, and the local CMS's where each local account number exists;
(c) using the local account number obtained from the visiting patron to locate a corresponding UID for the visiting patron in the remote account data repository;
(d) in the remote account data repository, using the UID to identify all local account numbers that correspond to the UID for the patron;
(e) communicating the local account numbers and the local CMS's where each of the local account number exist back to the CMS of the local casino property;
(f) the CMS of the local casino property initiating communication directly with the CMS of each of the casino properties that have the local account numbers, and retrieving the patron records of the identified local account numbers directly from the CMS's of the other casino properties and without further assistance from the remote account data repository or a central database of patron activity data; and
(g) the CMS of the local casino property updating its patron record for the visiting patron with any retrieved patron records from the other casino properties, the local casino property thereby updating the local CMS with patron records of the visiting patron from the other casino properties.

12. The method of claim 11 further comprising:
(h) viewing the patron records of the visiting patron for each of the casino properties on a display screen on an individual property by property basis.

13. The method of claim 11 wherein at least some visiting patrons have more than one local account number, each of the local account numbers being assigned the same UID in the remote account data repository, wherein step (f) further comprises retrieving each of the local account number records for the patrons that have more than one local account number.

14. A computer-implemented method of allowing a patron to have more than one local account number within an enterprise of affiliated local casino properties while allowing local casino management systems (CMS's) at the local casino properties to store and relate the multiple account numbers to each other, the method comprising:
(a) allowing an existing patron of one of the affiliated local casino properties to obtain a new local account number at any of the affiliated local casino properties, the patron providing identifying information when obtaining the new local account number; and
(b) assigning a universal patron identifier number (UID) to each local account number, wherein the same UID is assigned to each local account number that has sufficiently similar identifying information to determine that the respective identities of the patrons are the same.

15. The method of claim 14 further comprising:
(c) storing the local account numbers, identifying information associated with the local account numbers, and the UID's for each of the local account numbers in a remote account data repository, wherein the UID for the existing patron who obtains a new local account number is assigned using the data in the remote account data repository.

16. The method of claim 14 wherein the identifying information includes one or more of the existing patron's name, address, and telephone number.
